(19) United States
(12) Patent Application Publication
(10) Pub. No.: US 2019/0362266 A1
(43) Pub. Date: Nov. 28, 2019

(54) SYSTEMS AND METHODS FOR TEXT ATTRIBUTE DETERMINATION USING A CONDITIONAL RANDOM FIELD MODEL

(71) Applicant: BEIJING DIDI INFINITY TECHNOLOGY AND DEVELOPMENT CO., LTD., Beijing (CN)

(72) Inventors: Dapan DAI, Beijing (CN); Qi SONG, Beijing (CN)

(73) Assignee: BEIJING DIDI INFINITY TECHNOLOGY AND DEVELOPMENT CO., LTD., Beijing (CN)

(21) Appl. No.: 16/536,343

(22) Filed: Aug. 9, 2019

Related U.S. Application Data
(63) Continuation of application No. PCT/CN2017/087572, filed on Jun. 8, 2017.

(51) Int. Cl. G06N 20/00; G06F 16/245

(52) U.S. Cl. CPC G06N 20/00; G06F 16/245

(57) ABSTRACT

The present disclosure relates to a system and method for determining an attribute for each of one or more subsets of a text of a query. The method includes receiving, via a network, a query from a terminal device. The method may also include extracting a text from the query and determining one or more subsets of the text. The method may further include obtaining a trained conditional random field (CRF) model and determining an attribute for each of the one or more subsets of the text based on the CRF model and the each of the one or more subsets of the text.

### CROSS-REFERENCE TO RELATED APPLICATION

This application is a continuation of International Application No. PCT/CN2017/087572, filed on Jun. 8, 2017, designating the United States of America, the contents of which are hereby incorporated by reference in their entirety.

### TECHNICAL FIELD

The present disclosure generally relates to systems and methods for on-demand services, and in particular, systems and methods for text attribute determination using a conditional random field model.

### BACKGROUND

Internet-based on-demand services, such as a search service, have become increasingly popular because of their convenience. When a user requests a search service (e.g., a map search service), a text of a query inputted by the user may be commonly in the form of “where” and “what.” The text of the query is commonly labeled based on a dictionary or manually labeled. However, it is not practical to manually label such large scale queries. There is a need of a high-performance text labeling technique to determine the attribute of the text.

### SUMMARY

According to an aspect of the present disclosure, a system is provided. The system may include at least one computer-readable storage medium including a set of instructions for managing supply of services. The system may include at least one processor in communication with the at least one storage medium. The at least one processor may receive, via a network, a query from a terminal device. The at least one processor may determine one or more subsets of the text. The at least one processor may also obtain a trained conditional random field (CRF) model. The at least one processor may further determine an attribute for each of the one or more subsets of the text based on the CRF model and the each of the one or more subsets of the text.

According to another aspect of the present disclosure, a method is provided. The method may be implemented on at least one device each of which has at least one processor, a storage, and a communication platform to connect to a network. The at least one device may receive, via the network, a query from a terminal device. The at least one device may also determine one or more subsets of the text. The at least one device may further obtain a trained conditional random field (CRF) model. The at least one device may also determine an attribute for each of the one or more subsets of the text based on the CRF model and the each of the one or more subsets of the text.

According to another aspect of the present disclosure, a non-transitory machine-readable storage medium may include instructions. When the non-transitory machine-readable storage medium accessed by at least one processor of an online on-demand service platform from a requester terminal, the instructions may cause the at least one processor to perform one or more of the following operations. The instructions may cause the at least one processor to receive a query from a terminal device. The instructions may cause the at least one processor to extract a text from the query. The instructions may also cause the at least one processor to determine one or more subsets of the text. The instructions may further cause the at least one processor to obtain a trained conditional random field (CRF) model. The instructions may also cause the at least one processor to determine an attribute for each of the one or more subsets of the text based on the CRF model and the each of the one or more subsets of the text.

In some embodiments, the attribute for each of the one or more subsets of the text may include at least one of a spatial attribute or an entity attribute.

In some embodiments, the attributes for the one or more subsets of the text may include at least a spatial attribute having a first label.

In some embodiments, the attributes for the one or more subsets of the text may further include at least an entity attribute having a second label.

In some embodiments, the at least one device may further determine a probability for the attribute for the each of the one or more subsets of the text.

In some embodiments, the trained CRF model may be generated according to a process for generating a CRF model. The process may include obtaining a preliminary CRF model. The process may include obtaining a plurality of training samples. The process may include determining a feature template. The process may include determining one or more feature functions based on the plurality of training samples and the feature template. The process may include training the preliminary CRF model based on the one or more feature functions to generate the trained CRF model.

In some embodiments, the plurality of training samples may include a historical sample. The historical sample may be generated according to a process for generating the historical sample. The process may include obtaining a historical query. The process may include extracting a text from the historical query. The process may include determining at least one subset of the text of the historical query. The process may include obtaining a point of interest (POI) associated with the historical query. The process may include determining an attribute for the at least one subset of the text of the historical query according to the POI associated with the historical query. The process may include generating the historical sample according to the determined attribute and the at least one subset of the text of the historical query.

In some embodiments, the feature template may include at least one of a fine feature, a generalized feature, or an individualized feature.

In some embodiments, the fine feature may include at least one of a feature of a current word, a feature of a preceding word of the current word, a feature of a following word of the current word, a relationship of the current word and the preceding word of the current word, a relationship of the current word and the following word of the current word, a relationship of the preceding word of the current word and the following word of the current word, a relationship of the feature of the current word and the feature of the preceding word of the current word, a relationship of the feature of the current word and the feature of the following word of the current word, or a relationship of the feature of the preceding word of the current word and the feature of the following word of the current word.

In some embodiments, the generalized feature may include at least one of a number, a letter, a character size, a prefix, or a suffix.

In some embodiments, the individualized feature may include at least one of identity number information related to a user associated with a terminal device, a query time, or location information of the terminal device.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an exemplary on-demand service system according to some embodiments of the present disclosure;

FIG. 2 is a block diagram of an exemplary mobile device configured to implement a specific system disclosed in the present disclosure.

FIG. 3 is a block diagram illustrating an exemplary computing device according to some embodiments of the present disclosure;

FIG. 4 is a block diagram illustrating an exemplary processing engine according to some embodiments of the present disclosure;

FIG. 5 is a flowchart of an exemplary process for determining an attribute for one or more subsets of a text of a query according to some embodiments of the present disclosure;

FIG. 6 is a flowchart of an exemplary process for determining a conditional random field (CRF) model according to some embodiments of the present disclosure; and

FIG. 7 is a flowchart of an exemplary process for determining training samples according to some embodiments of the present disclosure.

### DETAIL DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to process a query, it should also be understood that this is only one exemplary embodiment. The system or method of the present disclosure may be applied to any other kind of search service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity that may request or order a service. Also, the term “driver,” “provider,” “service provider,” and “supplier” in the present disclosure are used interchangeably to refer to an individual, entity or a tool that may provide a service or facilitate the providing of the service. The term “user” in the present disclosure may refer to an individual, an entity that may request a service, order a service, provide a service, or facilitate the providing of the service. For example, the user may be a passenger, a driver, an operator, or the like, or any combination thereof. In the present disclosure, “passenger,” “user equipment,” “user terminal,” and “passenger terminal” may be used interchangeably, and “driver” and “driver terminal” may be used interchangeably.

The term “service request” refers to a request that may be initiated by a user (e.g., a passenger, a requester, an operator, a service requester, a customer, a driver, a provider, a service provider, a supplier). The service request may relate to the point of interest (POI) where the user may want to go.

The system may find applications in many fields, e.g., a taxi transportation service, a driving application, a distributing application, a map application, or a navigation application, etc.

In accordance with some embodiments of the present disclosure, search service may be processed using one or more machine learning algorithms, such as a neural network algorithm, a sort algorithm, a regression algorithm, an instance-based algorithm, a normalized algorithm, a decision tree algorithm, a Bayesian algorithm, a clustering algorithm, an association rule algorithm, a deep learning algorithm, and a reduced dimension algorithm, or the like, or any combination thereof. For example, the neural network algorithm may include, a recurrent neural network, a perceptron neural network, a back propagation, a Hopfield network, a self-organizing map (SOM), or a learning vector quantization (LVQ), etc. The regression algorithm may include an ordinary least square, a logistic regression, a stepwise regression, a multivariate adaptive regression spline, a locally estimated scatterplot smoothing, etc. The sort algorithm may include an insert sort, a selection sort, a merge sort, a heap sort, a bubble sort, a shell sort, a comb sort, a counting sort, a bucket sort, a radix sort, or the like, or any combination thereof. The instance-based algorithm may include a k-nearest neighbor (KNN), a learning vector quantization (LVQ), a self-organizing map (SOM), etc. The normalized algorithm may include a RIDge regression, a least absolute shrinkage and selection operator (LASSO), or an elastic net. The decision tree algorithm may include a classification and regression tree (CART), an iterative Dichotomiser 3 (ID3), a C4.5, a chi-squared automatic interaction detection (CHAID), a decision stump, a random forest, a multivariate adaptive regression spline (MARS), or a gradient boosting machine (GBM), etc. The Bayesian algorithm may include a naive Bayesian algorithm, an averaged one-dependence estimators (AODE) or a Bayesian belief network (BBN), etc. The kernel-based algorithm may include a support vector machine (SVM), a radial basis function (RBF), or a linear discriminate analysis (LDA), etc. The clustering algorithm may include a k-means clustering algorithm, a fuzzy c-mean clustering algorithm, a hierarchical clustering algorithm, a Gaussian clustering algorithm, a MST based clustering algorithm, a kernel k-means clustering algorithm, a density-based clustering algorithm, or the like. The association rule algorithm may include an Apriori algorithm or an Eclat algorithm, etc. The deep learning algorithm may include a restricted Boltzmann machine (RBN), a deep belief networks (DBN), a convolutional network, a stacked autoencoders, etc. The reduced dimension algorithm may include a principle component analysis (PCA), a partial least square regression (PLS), a Sammon mapping, a multi-dimensional scaling (MDS), a Projection Pursuit, etc.

An aspect of the present disclosure relates to systems and methods for determining an attribute for one or more subsets of a text of a query for an on-demand service (e.g., a search service). The system may extract a text from the query and determine one or more subsets of the text of the query. The system may further obtain a trained CRF model and determine an attribute for each of the one or more subsets of the text of the query. By determining an attribute for each of the one or more subsets of the query, the efficiency of the search service platform is enhanced.

It should be noted that online on-demand transportation service, such as online taxi-hailing, is a new form of service rooted only in post-Internet era. It provides technical solutions to users and service providers that could raise only in post-Internet era. In pre-Internet era, when a user hails a taxi on street, the taxi request and acceptance occur only between the passenger and one taxi driver that sees the passenger. If the passenger hails a taxi through a telephone call, the service request and acceptance by a service provider may occur only between the passenger and the service provider (e.g., a taxi company or agent). Online taxi, however, allows a user of the service to reserve a service and automatic distribute the reservation service request to a vast number of individual service providers (e.g., taxi drivers) distance away from the user. It also allows a plurality of service providers to respond the service request simultaneously and in real-time. Therefore, through the Internet, the online on-demand transportation systems may provide a much more efficient transaction platform for the users and the service providers that may never meet in a traditional pre-Internet transportation service system. Allocating appointment orders provides a service for both requesters and service providers efficiently.

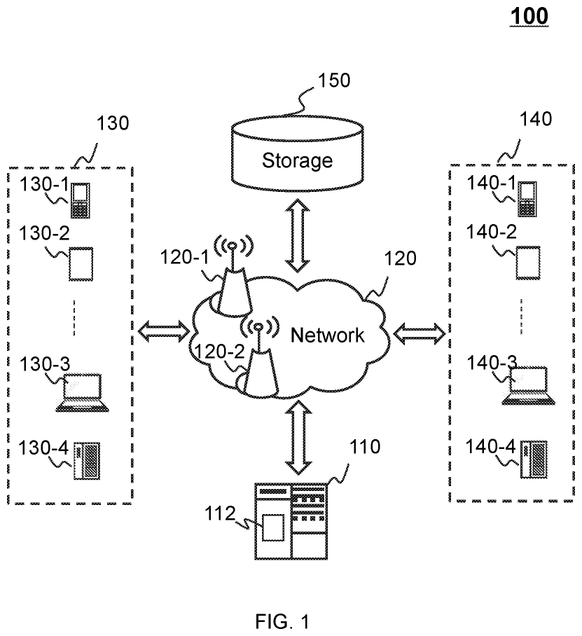

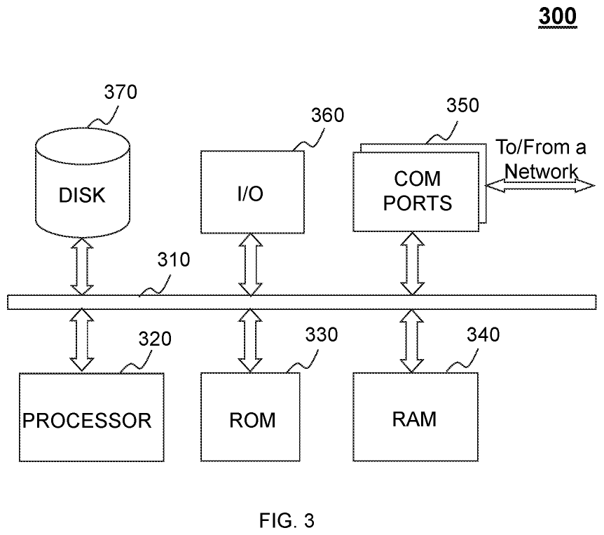

FIG. 1 is a block diagram of an exemplary on-demand service system 100 according to some embodiments. For example, the on-demand service system 100 may be an online search service platform for transportation service such as taxi hailing, chauffeur service, express car, carpool, bus service, driver hire and shuttle service by searching a location. The on-demand service system 100 may be an online platform including a server 110, a network 120, one or more user terminals (e.g., one or more passenger terminals 130, driver terminals 140), and a storage 150. The server 110 may include a processing engine 112. It should be noted that the on-demand service system 100 shown in FIG. 1 is merely an example, and not intended to be limiting. In some embodiments, the on-demand service system 100 may include the passenger terminal(s) 130 or the driver terminal(s) 140. For example, in a navigation system, a user may use a navigation application installed in his/her terminal to search a location, and the on-demand service system 100 may determine one or more search results associated with the location through inputting a query by the user. The use of “passenger” and “service provider/driver/driver terminal” is regarded to the online search service platform. When “service requester,” “user,” “user terminal,” “terminal,” or “user equipment” is used, it is regarded to all location-based service (LBS) including the online search service and the navigation service. In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the one or more user terminals (e.g., the one or more passenger terminals 130, driver terminals 140), and/or the storage 150 via the network 120. As another example, the server 110 may be directly connected to the one or more user terminals (e.g., the one or more passenger terminals 130, driver terminals 140), and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 300 having one or more components illustrated in FIG. 3 in the present disclosure.

In some embodiments, the server 110 may include a processing engine 112. The processing engine 112 may process information and/or data. The information and/or data may be related to a query. The query may be inputted by a passenger terminal or driver terminal. For example, the processing engine 112 may determine an attribute for a text or one or more subsets of the text of the query. The processing engine 112 may further determine one or more search results based on the query obtained from the passenger terminal or driver terminal. The passenger terminal or driver terminal may select a point of interest (POI) from the one or more search results. The POI may be a location that the passenger or driver may want to go. In some embodiments, the processing engine 112 may include one or more processing engines (e.g., signal-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the one or more passenger terminals 130 the one or more driver terminal 140, or the storage 150) may send information and/data to other component(s) in the on-demand service system 100 via the network 120. For example, the server 110 may obtain/acquire service request from the requestor terminal 130 via the network 120. As another example, the server 110 may receive training samples from storage 150 via the network 120. In some embodiments, the network 120 may be any type of wired or wireless network, or any combination thereof. Merely by way of example, the network 120 may include a cable network, a wireline network, an optical fiber network, a telecommunications network, an intranet, an internet, a local area network (LAN), a wide area network (WAN), a wireless local area network (WLAN), a metropolitan area network (MAN), a wide area network (WAN), a public telephone switched network (PTSN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a passenger may be a user of the passenger terminal 130. In some embodiments, the user of passenger terminal 130 may be someone other than the passenger. For example, a user A of the passenger terminal 130 may use the passenger terminal 130 to send a search request for the passenger. In some embodiments, a driver may be a user of the driver terminal 130. In some embodiments, the user of the driver terminal 140 may be someone other than the driver. For example, a user B of the driver terminal 140 may use the driver terminal 140 to send a search service request for the driver. In some embodiments, “passenger” and “passenger terminal” may be used interchangeably, and “driver” and “driver terminal” may be used interchangeably.

In some embodiments, the passenger terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the passenger terminal 130 may be a device with positioning technology for locating the position of the service requester and/or the passenger terminal 130.

In some embodiments, the driver terminal 140 may be similar to, or the same device as the passenger terminal 130. In some embodiments, the driver terminal 140 may be a device with positioning technology for locating the position of the driver and/or the driver terminal 140. In some embodiments, the passenger terminal 130 and/or the driver terminal 140 may communicate with other positioning device to determine the position of the service requester, the passenger terminal 130, the driver, and/or the driver terminal 140. In some embodiments, the passenger terminal 130 and/or the driver terminal 140 may send positioning information to the server 110.

The storage 150 may store data and/or instructions. For example, the data may be a training model, one or more training samples, historical orders, or the like, or a combination thereof. In some embodiments, the storage 150 may store data obtained from the one or more user terminals (e.g., the one or more passenger terminals 130, driver terminals 140). In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components in the on-demand service system 100 (e.g., the server 110, the one or more user terminals, etc.). One or more components in the on-demand service system 100 may access the data and/or instructions stored in the storage 150 via the network 120. In some embodiments, the storage 150 may be directly connected to or communicate with one or more components in the on-demand service system 100 (e.g., the server 110, the one or more user terminals, etc.). In some embodiments, the storage 150 may be part of the server 110.

In some embodiments, one or more components in the on-demand service system 100 (e.g., the server 110, the one or more user terminals, etc.) may have a permission to access the storage 150. In some embodiments, one or more components in the on-demand service system 100 may read and/or modify information relating to the service requester, driver, and/or the public when one or more conditions are met. For example, the server 110 may read and/or modify one or more users' information after a service.

In some embodiments, information exchanging of one or more components of the on-demand service system 100 may be achieved by way of requesting a search service. The object of the search service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the on-demand service system 100 performs, the element may perform through electrical signals and/or electromagnetic signals. For example, when a service requestor terminal 130 processes a task, such as making a determination, identifying or selecting an object, the requestor terminal 130 may operate logic circuits in its processor to process such task. When the service requestor terminal 130 sends out a service request to the server 110, a processor of the service requestor terminal 130 may generate electrical signals encoding the request. The processor of the service requestor terminal 130 may then send the electrical signals to an output port. If the service requestor terminal 130 communicates with the server 110 via a wired network, the output port may be physically connected to a cable, which further transmit the electrical signal to an input port of the server 110. If the service requestor terminal 130 communicates with the server 110 via a wireless network, the output port of the service requestor terminal 130 may be one or more antennas, which convert the electrical signal to electromagnetic signal. Similarly, a service provider terminal 130 may process a task through operation of logic circuits in its processor, and receive an instruction and/or service request from the server 110 via electrical signal or electromagnet signals. Within an electronic device, such as the service requestor terminal 130, the service provider terminal 140, and/or the server 110, when a processor thereof processes an instruction, sends out an instruction, and/or performs an action, the instruction and/or action is conducted via electrical signals. For example, when the processor retrieves or saves data from a storage medium, it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

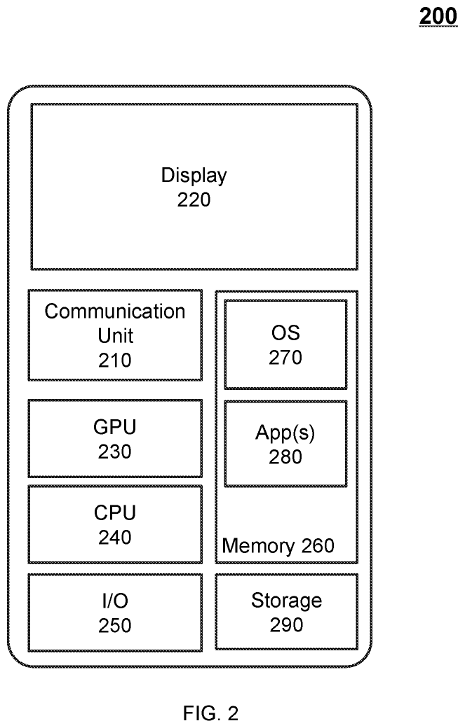

FIG. 2 is a block diagram of an exemplary mobile device configured to implement a specific system disclosed in the present disclosure. In some embodiments, a user terminal device configured to display and communicate information related to locations may be a mobile device 200. The mobile device may include but is not limited to a smartphone, a tablet computer, a music player, a portable game console, a GPS receiver, a wearable calculating device (e.g. glasses, watches, etc.), or the like. The mobile device 200 may include one or more central processing units (CPUs) 240, one or more graphical processing units (GPUs) 230, a display 220, a memory 260, a communication unit 210, a storage unit 290, and one or more input/output (I/O) devices 250. Moreover, the mobile device 200 may also be any other suitable component that includes but is not limited to a system bus or a controller (not shown in FIG. 2). As shown in FIG. 2, a mobile operating system 270 (e.g. 10S, Android, Windows Phone, etc.) and one or more applications 280 may be loaded from the storage unit 290 to the memory 260 and implemented by the CPUs 240. The application 280 may include a browser or other mobile applications configured to receive and process information related to a query (e.g., a name of a location) inputted by a user in the mobile device 200. The passenger/driver may obtain information related to one or more search results through the system I/O device 250, and provide the information to the server 110 and/or other modules or units of the on-demand service system 100 (e.g., the network 120).

In order to implement various modules, units and their functions described above, a computer hardware platform may be used as hardware platforms of one or more elements (e.g., the server 110 and/or other sections of the on-demand service system 100 described in FIG. 1 through FIG. 7). Since these hardware elements, operating systems and program languages are common, it may be assumed that persons skilled in the art may be familiar with these techniques and they may be able to provide information required in the on-demand service according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the Figures.

FIG. 3 is a block diagram illustrating exemplary hardware and software components of a computing device 300 on which the server 110, the one or more user terminals (e.g., the one or more passenger terminals 130, driver terminals 140) may be implemented according to some embodiments of the present disclosure. The computing device 300 may be configured to perform one or more functions of the server 110, passenger terminal 130, and driver terminal 140 disclosed in this disclosure. For example, the processing engine 112 may be implemented on the computing device 300 and configured to perform functions of the processing engine 112 disclosed in this disclosure.

The computing device 300 may be a general-purpose computer or a special purpose computer, both may be used to implement an on-demand service system 100 for the present disclosure. The computing device 300 may be used to implement any component of the on-demand service system 100 as described herein. For example, the processing engine 112 may be implemented on the computing device 300, via its hardware, software program, firmware, or a combination thereof. Although only one such computer is shown, for convenience, the computer functions relating to the search service as described herein may be implemented in a distributed fashion on a number of similar platforms to distribute the processing load.

The computing device 300, for example, may include COM ports 250 connected to and from a network connected thereto to facilitate data communications. The computing device 300 may also include a processor 320, in the form of one or more processors, for executing program instructions. The exemplary computer platform may include an internal communication bus 310, program storage and data storage of different forms, for example, a disk 370, and a read only memory (ROM) 330, or a random access memory (RAM) 340, for various data files to be processed and/or transmitted by the computer. The exemplary computer platform may also include program instructions stored in the ROM 330, RAM 340, and/or other type of non-transitory storage medium to be executed by the processor 320. The methods and/or processes of the present disclosure may be implemented as the program instructions. The computing device 300 may also include an I/O component 360, supporting input/output between the computer and other components therein. The computing device 300 may also receive programming and data via network communications.

The computing device 300 may also include a hard disk controller communicated with a hard disk, a keypad/keyboard controller communicated with a keypad/keyboard, a serial interface controller communicated with a serial peripheral equipment, a parallel interface controller communicated with a parallel peripheral equipment, a display controller communicated with a display, or the like, or any combination thereof.

Merely for illustration, only one CPU and/or processor is described in the computing device 300. However, it should be noted that the computing device 300 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 300 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

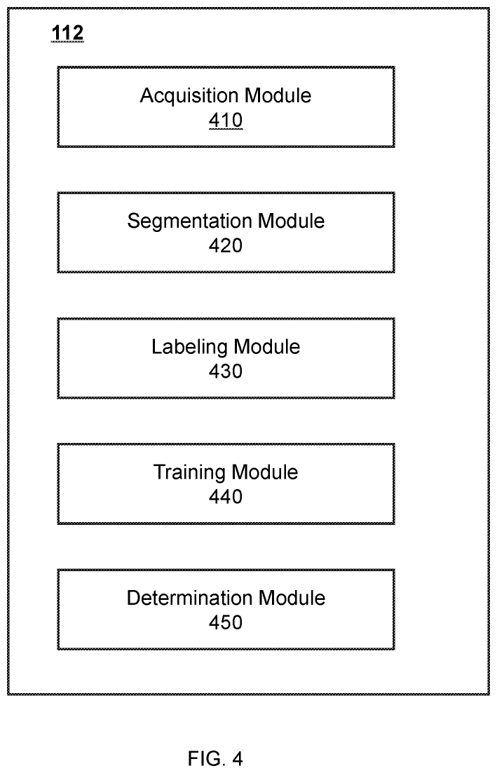

FIG. 4 is a block diagram illustrating an exemplary processing engine 112 according to some embodiments of the present disclosure. The processing engine 112 may be in communication with a computer-readable storage (e.g., the storage 150, the passenger terminal 130, or the driver terminal 140) and may execute instructions stored in the computer-readable storage medium. The processing engine 112 may include an acquisition module 410, a segmentation module 420, a labeling module 430, a training module 440, and a determination module 450.

The acquisition module 410 may be configured to obtain a query. The query may be a historical query or online query. In some embodiments, the acquisition module 410 may obtain the historical query entered by a user associated with a terminal device (e.g., the passenger terminal 130) via the network 120. In some embodiments, the acquisition module 410 may obtain the online query inputted by the user associated with the terminal device via the network 120.

The acquisition module 410 may also be configured to obtain a text from the query. A plurality of techniques may be used in the text extraction, for example, a natural language processing technique, a speech recognition technique, an image recognition technique, a database technique, or the like, or any combination thereof. For example, the speech recognition technique may be used to analyze the file “*.amr” and generate a text (e.g., “Hai/Dian/Qing/Hua/Da/Xue”).

The acquisition module 410 may further be configured to obtain a search record of the user associated with the terminal device (e.g., the passenger terminal 130) via the network 120. The search record may include a text of the historical query, a POI selected by the user associated with the terminal device, identity number information related to the user associated with the terminal device, a query time, location information of the terminal device, or the like, or any combination thereof.

The acquisition module 410 may be configured to obtain a training sample. In some embodiments, the training sample may be generated based on the labeling module 430. In some embodiments, the training sample may be generated based on a dictionary or manual operation.

The segmentation module 420 may be configured to segment a text of a query into one or more subsets based on a text segmentation. The query may be a historical query or an online query. A plurality of techniques may be used in the text segmentation, for example, a model based technique, a word segmentation technique, a sentence segmentation technique, a natural language processing technique, a neural network technique (e.g., Error Back Propagation (BP) algorithm), a Lexical Cohesion technique, a Lexical Chains technique, a Lexical Cohesion Profile technique, a Latent Semantic Analysis, a Local Context Analysis, an Aspect Hidden Markov Model, a Probabilistic Latent Semantic Analysis, or the like, or any combination thereof.

The labeling module 430 may be configured to label an attribute for each of the one or more subsets of a text of a query. A training sample may be generated based on the labeling operation. The query may be a historical query. The labeling module 430 may analyze a relationship of the historical query and a POI selected by a user associated with a user terminal. The labeling module 430 may assign a label “where” or a label “what” to each of the one or more subsets of the text of the historical query based on the relationship of the historical query and the POI. The labeling module 430 may label the attribute for each of the one or more subsets of the text of the historical query using the label “where” or the label “what.” The labeling module 430 may automatically label the attribute for each of the one or more subsets of the text of the historical query.

The training module 440 may be configured to train a model. The model may be a CRF model. The training module 440 may determine parameters of the CRF model based on one or more training samples. The training module 440 may train the CRF model based on different samples. In some embodiments, the different samples may be obtained from different regions (e.g., samples of Beijing, samples of New York City).

The determination module 450 may be configured to determine an attribute for each of one or more subsets of a text of a query based on the CRF model. The attribute may be an entity attribute or a spatial attribute, or the like, or a combination thereof. The attribute may have a label. For example, the spatial attribute may have a label “where” and the entity attribute may have a label “what.” In some embodiments, the determination module 450 may also be configured to determine an attribute sequence for the text (which may include one or more subsets). The attribute sequence for the text may include some or all of the attributes of the one or more subsets of the text. In some embodiments, the determination module 450 may determine two or more attribute sequences (e.g., a first attribute sequence, a second attribute sequence) for the text. In some embodiments, the determination module 450 may further determine a probability for the determined attribute sequence(s) for the text.

It should be noted that the descriptions above in relation to processing engine 112 is provided for the purposes of illustration, and not intended to limit the scope of the present disclosure. For persons having ordinary skills in the art, various variations and modifications may be conducted under the guidance of the present disclosure. However, those variations and modifications do not depart the scope of the present disclosure. For example, the training module 440 may include a correction unit (not shown in figures) to correct a trained CRF model. As another example, the determination module 450 be used to segment a text. Similar modifications should fall within the scope of the present disclosure.

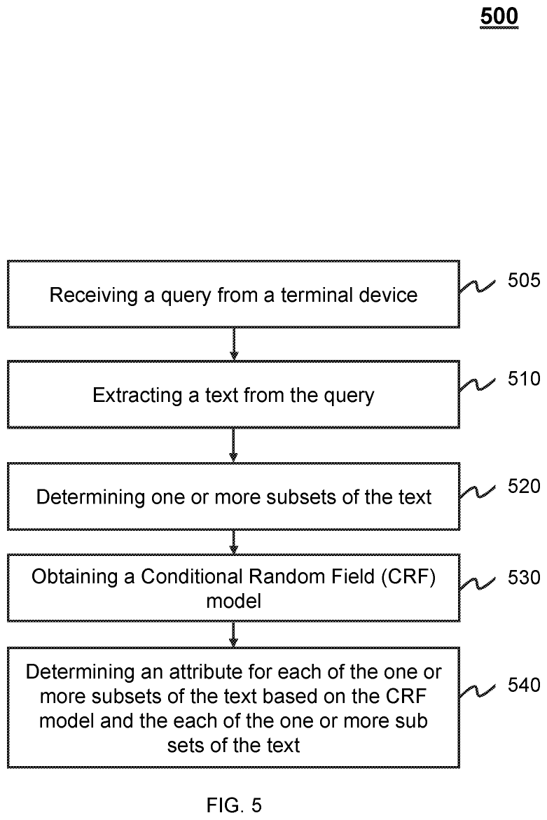

FIG. 5 is a flowchart of an exemplary process 500 for determining an attribute for each of one or more subsets of a text of a query according to some embodiments of the present disclosure. In some embodiments, the process 500 for determining the attribute for each of the one or more subsets of the text of the query may be implemented in the system 100 as illustrated in FIG. 1. For example, the process 500 may be implemented in a user terminal (e.g., the passenger terminal 130, driver terminal 140) and/or the server 110. The process 500 may also be implemented as one or more instructions stored in the storage 150 and called and/or executed by the processing engine 112.

In 505, the processing engine 112 (e.g., the acquisition module 410) may receive a query from a terminal device. The terminal device may be the passenger terminal 130 or the driver terminal 140. The query may be an online query. As used herein, the online query may be a query inputted by a user through the terminal device (e.g., the passenger terminal 130, the driver terminal 140), which may be transmitted to the server 110 via the network 120. The query may be in a format of text, audio content, graphics, images, video content, or the like, or any combination thereof. For example, a user may input a text by an input method (e.g., Sougou™ input method) built-in the terminal device (e.g., the passenger terminal 130, the driver terminal 140). The query may be a speech entered by a user associated with a passenger terminal 130 (via, for example, a microphone of the passenger terminal 130) to indicate the location the user wants to go. The speech may be in a form of “*.amr.” The server 110 (or the passenger terminal 130) may determine the content of based on the audio file and generate a text accordingly.

In 510, the processing engine 112 (e.g., the acquisition module 410) may extract a text from the query. A plurality of techniques may be used in the text extraction, for example, a natural language processing technique, a speech recognition technique, an image recognition technique, a database technique, or the like, or any combination thereof. For example, the speech recognition technique may be used to analyze the file “*.amr” and generate a text (e.g., “Hai/Dian/Qing/Hua/Da/Xue”).

In 520, the processing engine 112 (e.g., the segmentation module 420) may determine one or more subsets of the text A plurality of techniques may be used for determining one or more subsets of the text including, for example, a model based technique, a word segmentation technique, a sentence segmentation technique, a natural language processing technique, a neural network technique (e.g., Error Back Propagation (BP) algorithm), a Lexical Cohesion technique, a Lexical Chains technique, a Lexical Cohesion Profile technique, a Latent Semantic Analysis, a Local Context Analysis, an Aspect Hidden Markov Model, a Probabilistic Latent Semantic Analysis, or the like, or any combination thereof.

In 530, the processing engine 112 (e.g., the acquisition module 410) may obtain a conditional random field (CRF) model. The CRF model may be a trained CRF model. That is, the parameters of the CRF model have been determined.

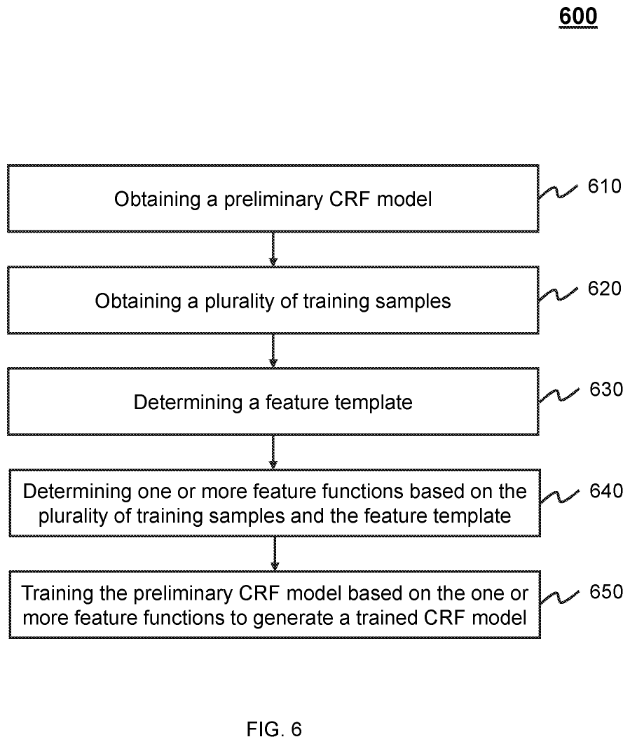

The CRF model may be associated with a region (e.g., a geographic area, a district, a city), a time period (e.g., rush hours), or the like, or any combination. For example, the CRF model may be associated with Beijing, which is trained based on training samples associated with Beijing. If the query is determined by the server 110 as being associated with Beijing (e.g., the query is related to a search for a POI in Beijing), the CRF model associated with Beijing may be obtained. In some embodiments, the CRF model may be trained based on an exemplary process 600 illustrated in FIG. 6.

In 540, the processing engine 112 (e.g., the determination module 450) may determine an attribute for each of the one or more subsets of the text based on the CRF model and the each of the one or more subsets of the text. The attribute for each of the one or more subsets of the text may include a spatial attribute and/or an entity attribute. The term “spatial attribute” used herein generally refers to a specific spatial scope (e.g., a residential district, a road). The term “entity attribute” used herein generally refers to a specific place (e.g., a name of a store, a name of a building, or a name of a university). The processing engine 112 may label a spatial attribute using a label “where.” The processing engine 112 may label an entity attribute using a label “what.” For example, the processing engine 112 may receive a query with a text “Haidian District Tsinghua University.” The text may be segmented into subset “Hadidian District” and subset “Tsinghua University.” The subset “Hadidian District” may be a spatial attribute (which may be labeled with “where”). The subset “Tsinghua University” may be an entity attribute (which may be labeled with “what”).

In some embodiments, the processing engine 112 (e.g., the determination module 450) may also determine an attribute sequence for the text (which may include one or more subsets). The attribute sequence for the text may include some or all of the attributes of the one or more subsets of the text. In some embodiments, the processing engine 112 may determine two or more attribute sequences (e.g., a first attribute sequence, a second attribute sequence) for the text. For example, for the text “Haidian District Tsinghua University,” the processing engine 112 may determine that the spatial attribute may be “Haidian District” (labeled as “where”) and the entity attribute may be “Tsinghua University” (labeled as “what”). The “where+what” may be the first attribute sequence of the text “Haidian District Tsinghua University.” As another example, for the same text “Haidian District Tsinghua University,” the processing engine 112 may also determine that the spatial attribute may be “Haidian District” (labeled as “where”) and the spatial attribute may be “Tsinghua University” (labeled as “where”). The “where+where” may be the second attribute sequence of the text “Haidian District Tsinghua University.” Accordingly, for the same text, the processing engine 112 may determine two attribute sequences, namely, “where+what” and “where+where.”

In some embodiments, the processing engine 112 (e.g., the determination module 450) may further determine a probability for the determined attribute sequence(s) for the text. For example, the processing engine may determine that the probability of the first attribute sequence “where+what” may be 0.8 and the probability of the second attribute sequence “where+where” may be 0.2. In some embodiments, the processing engine 112 may determine the probability of an attribute sequence based on training samples (e.g., the percentage of the attribute sequence of a text associated with a selected POI by users).

It should be noted that the processing engine 112 described above is provided for the purposes of illustration, and not intended to limit the scope of the present disclosure. Apparently, for persons having ordinary skills in the art, numerous variations and modifications may be conducted under the teaching of the present disclosure. However, those variations and modifications do not depart the protection scope of the present disclosure. In some embodiments, some steps may be reduced or added. For example, 510 may be omitted. A query may be in the form of a text and the text may be obtained without text extracting. As another example, 520 may be omitted. In some embodiments, a text may not need to be segmented (e.g., “China” or “Beijing”). Similar modifications should fall within the scope of the present disclosure.

FIG. 6 is a flowchart of an exemplary process 600 for determining the CRF model used for determining an attribute for each of one or more subsets of a text of a query according to some embodiments of the present disclosure. The process 600 may be used to train the CRF model used in the process 500 described above. In some embodiments, the process 600 for determining the CRF model may be implemented in the system 100 as illustrated in FIG. 1. For example, the process 600 may be implemented in a user terminal (e.g., the passenger terminal 130, driver terminal 140) and/or the server 110. The process 600 may be implemented as one or more instructions stored in the storage 150 and called and/or executed by the processing engine 112.

In 610, the processing engine 112 may obtain a preliminary CRF model. The training module 440 may first initialize the obtained preliminary CRF model by initializing the parameters of the preliminary CRF model. For example, the training module 440 may assign a plurality of values to the parameters of the preliminary CRF model.

The CRF model may assign T labels to each of one or more subsets of a text of an input query. The labeled attribute variables may be represented as:

y⁽ⁱ⁾=(y₁⁽ⁱ⁾,y₂⁽ⁱ⁾, . . . ,yₜ⁽ⁱ⁾, . . . ,y_{T}⁽ⁱ⁾) (1),

where y⁽ⁱ⁾ refers to an attribute sequence of a text of a query, i refers to a serial number of the attribute sequence, and yₜ refers to a label (e.g., a label of the attribute) of a particular subset of the text of the query.

In general, each attribute variable can assume a categorical value selected from a set of categorical values. A conditional probability p(y|x) of the CRF model represents the probability of a given attribute sequence y given a particular input sequence represented as:

x⁽ⁱ⁾=(x₁⁽ⁱ⁾,x₂⁽ⁱ⁾, . . . ,xₜ⁽ⁱ⁾, . . . ,x_{T}⁽ⁱ⁾) (2),

where x⁽ⁱ⁾ refers to the text of the query, i refers to a serial number of the query, and xₜ refers to a particular subset of the text of the input query. The conditional probability may be described as:

$$p ( y \vert x ) = \frac{1}{Z ( x )} exp \{ {\sum }_{k = 1}^{K} {λ}_{k} {f}_{k} ( {y}_{t} , {y}_{t - 1} , {x}_{t} ) \} , \qquad ( 3 )$$

where the fₓ(yₜ,yₜ₋₁,xₜ) refers to a feature function, λₖ refers to a weight parameter, and K refers to the number of the feature functions. Z(x) refers to a partition function that normalizes the exponential form of the above expression to correspond to a probability distribution, which may be described as:

Z(x)=Σ_{y} exp{Zₖ₌₁^{K}λₖfₖ(yₜ,yₜ₋₁,xₜ)} (4).

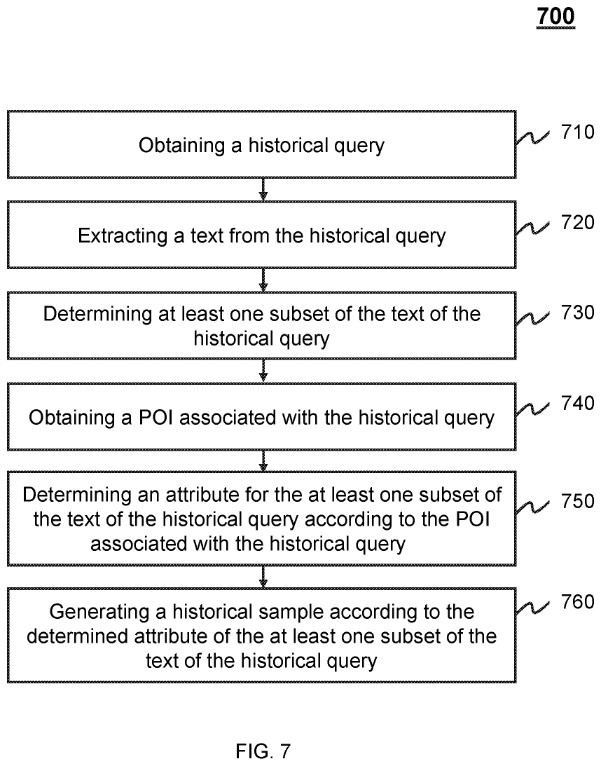

In 620, the processing engine 112 may obtain a plurality of training samples. The training samples may include one or more samples generated based on historical service orders. In some embodiments, the training samples may be generated based on historical service orders in a particular region (e.g., a geographic area, a district, a city), over a particular time period (e.g., rush hours), or the like, or any combination. For example, one or more historical samples may be generated based on historical service orders in Beijing over last two months during rush hours. In some embodiments, the training samples may include at least one historical sample (e.g., Table 1 below). In some embodiments, the historical sample may be generated based on an exemplary process 700 illustrated in FIG. 7.

In 630, the processing engine 112 may determine a feature template. The feature template may be configured to describe the feature(s) of a text of a query. The feature(s) of the text of the query may include a fine feature, a generalized feature, an individualized feature, or the like, or any combination thereof.

In some embodiments, the feature template may be a unigram template or a bigram template. For example, the feature template may be a unigram template described as:
#Unigram
U00: %×[−1, 0]
U01: %×[0, 0]
U02: %×[1, 0]
U03: %×[−1, 0]/%×[0, 0]
U04: %×[0, 0]/%×[1, 0]
U05: %×[−1, 0]/%×[1, 0]
U10: %×[−1, 1]
U11: %×[0, 1]
U12: %×[1, 1]
U13: %×[−1, 1]/%×[0, 1]
U14: %×[0, 1]/%×[1, 1]
U15: %×[−1, 1]/%×[1, 1].

The “U00: %×[−1, 0]” may represent a preceding word of a current word. The “U01: %×[0, 0]” may represent the current word. The “U02: %×[1, 0]” may represent a following word of the current word. The “U03: %×[−1, 0]/%×[0, 0]” may represent a relationship of the current word and the preceding word of the current word. The “U04: %×[0, 0]/%×[1, 0]” may represent a relationship of the current word and the following word of the current word. The “U05: %×[−1, 0]/%×[1, 0]” may represent a relationship of the preceding word of the current word and the following word of the current word. The “U10: %×[−1, 1]” may represent a feature of the preceding word of the current word. The feature of the preceding word of the current word may be a number, a letter, a character size, a prefix, a suffix, or the like. The “U11: %×[0, 1]” may represent a feature of the current word. The feature of the current word may be a number, a letter, a character size, a prefix, a suffix, or the like. The “U12: %×[1, 1]” may represent a feature of the following word of the current word. The feature of the following word of the current word may be a number, a letter, a character size, a prefix, a suffix, or the like. The “U13: %×[−1, 1]/%×[0, 1]” may represent a relationship of the feature of the preceding word of the current word and the feature of the feature of the current word. The “U14: %×[0, 1]/%×[1, 1]” may represent a relationship of the feature of the current word and the feature of the following word of the current word. The “U15: %×[−1, 1]/%×[1, 1]” may represent a relationship of the feature of the preceding word of the current word and the feature of the following word of the current word.

The fine feature may include a feature of a current word, a feature of a preceding word of the current word, a feature of a following word of the current word, a relationship of the current word and the preceding word of the current word, a relationship of the current word and the following word of the current word, a relationship of the preceding word of the current word and the following word of the current word, a relationship of the feature of the current word and the feature of the preceding word of the current word, a relationship of the feature of the current word and the feature of the following word of the current word, a relationship of the feature of the preceding word of the current word and the feature of the following word of the current word, or the like, or any combination thereof.

The fine feature may include fine-grained information for query labeling. For example, the training samples may include many names of universities. The names of the universities in the training samples may include “Beijing University,” “Beijing Jiaotong University,” “Beijing Keji University,” or the like. For a query having a text “Beijing University,” if the CRF model only relies on a feature of a current word but ignores a relationship of the current word and a following word of the current word, the CRF model may determine that “Beijing” is spatial attribute because “Beijing” is a city and “University” is an entity attribute. However, if the CRF model applies the fine feature, the CRF model may determine a relationship of “Beijing” and “University,” and determine that “Beijing University” should not be segmented, and the CRF model may determine “Beijing University” is an entity attribute. Therefore, the CRF model including a fine feature may determine an attribute for each of one or more subsets of a text of a query more accurately.

The generalized feature may include a part of speech, a number, a letter, a character size, a prefix, a suffix, or the like, or any combination thereof. The generalized feature may include sufficient features of a query on the CRF model to enhance a generalization ability of the CRF model. The generalization ability of the CRF model refers to the ability that the CRF model may be able to identify features of some new queries or texts that are not in the training samples.

For example, the training samples may include many names of buildings of a university. The names of the buildings of the university in the training samples may include “Tsinghua University Building 1,” “Tsinghua University Building 2,” and “Tsinghua University Building 3.” A user may input a query having a text “Tsinghua University Building 4.” The CRF model may not correctly determine an attribute of “Tsinghua University Building 4,” because the CRF does not define a feature of the number “4” or a feature of “Tsinghua University Building 4.” However, if the CRF model has originally defined the number feature, the CRF model may determine that “Tsinghua University Building 4” is similar to “Tsinghua University Building 1,” “Tsinghua University Building 2,” and “Tsinghua University Building 3,” and determine an entity attribute for “Tsinghua University Building 4.” As another example, the training samples may include many names of mansions. The names of the mansions in the training samples may only include “International Trade Mansion A,” “International Trade Mansion B,” and “International Trade Mansion C.” A user may input a query having a text “International Trade Mansion D,” the CRF model may not correctly determine an attribute for “International Trade Mansion D,” because the CRF does not define a feature of a capital letter. However, if the CRF model has originally defined the feature of capital letter, the CRF model may determine that “International Trade Mansion D” is similar to “International Trade Mansion A,” “International Trade Mansion B,” and “International Trade Mansion C,” and correctly determine attribute for “International Trade Mansion D.” Therefore, the CRF model including a generalized feature may determine an attribute for one or more subsets of a text of a new query.

The individualized feature may include identity number information related to a user associated with the terminal device, a query time, a query frequency, location information of the terminal device, or the like, or any combination thereof. For example, one or more subsets of a text of a query (e.g., a name of a restaurant, or a name of a store) inputted by a user during a time period (e.g., 11:30 am˜12:30 pm) may be entity attributes. The CRF model including an individualized feature may determine time information as the individualized feature.

As another example, user A may input a query having a text “Zhongguancun.” User A may frequently select a POI “Zhongguancun Subway,” but may occasionally select a POI that is “Zhongguancun Mansion.” For user A, the CRF model may determine “Zhongguancun” is more likely a spatial attribute because user A has selected the POI “Zhongguancun Subway” more often than other POIs. User B may input a query having the same text “Zhongguancun.” User B, however, may frequently select the POI “Zhongguancun Mansion,” but may occasionally select the POI “Zhongguancun Subway.” For user B, the CRF model may determine “Zhongguancun” is more likely an entity attribute because user B has selected the POI “Zhongguancun Mansion” more often than other POIs. Therefore, the CRF model including an individualized feature may more accurately determine an attribute for each of one or more subsets of a same text of different queries inputted by different users.

In 640, processing engine 112 may determine one or more feature functions based on the plurality of training samples and the feature template. A feature function may represent a feature of the plurality of training samples in a form of function. The feature function may be a transition feature function and an emission feature function (also referred to as state feature function). The transition feature function may be a binary function that indicates whether a transition (yₜ₋₁=i, yₜ=j) occurs. For example, the transition function may be described as:

f_{i,j}(yₜ₋₁,yₜ,xₜ)=ψ_{(y}_{ₜ₋₁}⁼ⁱ⁾ψ_{(y}_{ₜ}^{=j)}. (5),

where ψ refers to a particular function or a value (e.g., 1), i refers to a label (e.g., “where” or “what”), and j refers to a label (e.g., “where” or “what”).

The emission feature function may be a binary function that indicates whether an observation-dependent feature simultaneously occurs with state i. For example, the emission feature function may be described as:

f_{i,o}(yₜ₋₁,yₜ,xₜ)=ψ_{(y}_{ₜ}₌ᵢ₎ψ₍ₓ_{ₜ}₌ₒ₎ (6),

where o refers to a unigram. In some embodiments, ψ₍ₓ_{ₜ}₌₀₎ may be an arbitrary function on x. Different forms of the function may represent different features of a query.

In 650, the processing engine 112 (e.g., the training module 440) may train the preliminary CRF model based on the one or more feature functions to generate a trained CRF model.

In some embodiments, the preliminary CRF model may be trained based on a training operation of the plurality of training samples. For example, the plurality of samples may be represented by {(x⁽ⁱ⁾, y⁽ⁱ⁾)}ᵢ₌₁^{N}, wherein N refers to the number of the plurality of training samples. The plurality of training samples may be used as an input of the preliminary CRF model to determine parameters of the preliminary CRF model. The trained CRF model may be determined based on the determined CRF model parameters.

In some embodiments, the processing engine 112 may apply a maximum likelihood estimation to obtain the CRF model parameters. The likelihood function may be described as:

L(Λ)=Σᵢ₌₁^{N} log p(y⁽ⁱ⁾|x⁽ⁱ⁾;Λ) (7),

where Λ={λₖ} refer to weight parameters, i refers to a serial number of a training sample, N refers to the number of the plurality of training samples, y⁽ⁱ⁾ refers to an attribute sequence of the training sample, and x⁽ⁱ⁾ refers to a text of the training sample.

Maximum likelihood estimation may use the likelihood function to rank possible values of Λ={λₖ}. Specifically, the maximum likelihood estimation may determine what value of Λ={λₖ} should be to determine the maximum value of the likelihood function. The maximum value of the likelihood function may be described as:

Λₘₐₓ=argmax_{Λ}L(Λ) (8).

Thus, the parameters Λ={λₖ} for the maximum value of the likelihood function may determine a model that is as close to an empirical distribution as possible.

In some embodiments, the training module 440 may apply one or more algorithms to train the CRF model by iterating. The algorithms may include a stochastic gradient descent algorithm, a maximization (EM) algorithm, a Viterbi algorithm, an Improved Iterative Scaling (IIS) algorithm, a Generalized Iterative Scaling (GIS), or the like, or any combination thereof.

It should be noted that the process 600 described above is provided for the purposes of illustration, and not intended to limit the scope of the present disclosure. Apparently, for persons having ordinary skills in the art, numerous variations and modifications may be conducted under the teaching of the present disclosure. However, those variations and modifications do not depart the protection scope of the present disclosure. In some embodiments, the number of CRF models may not be limited. For example, the on-demand service system 100 may provide two or more CRF models that are specialized to determine an attribute for each or one or more subsets of a text of a query based on different cities. A user may input a query that relates to Beijing. The on-demand service system 100 may invoke a first type of CRF model associated with Beijing. The user may input a query that relates to Shanghai. The on-demand service system 100 may invoke a second type of CRF model associated with Shanghai. As another example, there may be a correction operation of the CRF model after 650. Similar modifications should fall within the scope of the present disclosure.

FIG. 7 is a flowchart of an exemplary process 700 for determining training samples according to some embodiments of the present disclosure. In some embodiments, the training samples used for training the preliminary CRF model in the process 600 may include at least one historical training sample generated according to an exemplary process 700 for generating a historical training sample illustrated in FIG. 7. In some embodiments, the process 700 for determining the sample may be implemented in the system 100 (e.g., the server 110). In some embodiments, the process 700 may be implemented as one or more instructions stored in the storage 150 and called and/or executed by the processing engine 112. In some embodiments, the process 700 may be implemented in a user terminal and/or a server, and the training sample determined or generated may be transmitted to the processing engine 112, or another suitable component of the system 100 for further processing.

The training samples may include one or more historical samples. The training samples may be determined based on the same method or a different method. For example, a historical sample may be determined based on a dictionary and some manual operations. Alternatively or additionally, a historical sample may be automatically labeled by an exemplary process illustrated in FIG. 7.

In 710, the processing engine 112 (e.g., the acquisition module 410) may obtain a historical query. The processing engine 112 may obtain the historical query from a search record of a user associated with a terminal device via the network 120. The query may include the information received from the user via the terminal device, for example, a text (e.g., “Haidian District” entered by the user at the terminal device), a sound, a figure, or the like, or any combination thereof. The query may also include geographical position information (e.g., the location information of the terminal device, departure location of the requester of the query, a POI associated with the historical query). The query may further include time information (e.g., the departure time associated with the query being 7:00 AM, the time of transmission of the query to the processing engine 112). The query may also include user information (e.g., the age of the requester of the query being 50 years old), or the like, or any combination thereof.

In some embodiments, the historical query may be stored in a database (e.g., a database in storage 150) or retrieved from another device. In some embodiments, the processing engine 112 may obtain a plurality of historical queries in 710. The plurality of historical queries may be the historical queries over a particular time period (e.g., in the last one month, in the last week) or associated with a particular location or area (e.g., Beijing, Shanghai, New York City).

In 720, the processing engine 112 (e.g., the acquisition module 410) may extract a text from the historical query. A plurality of techniques may be used in the text extraction, for example, a natural language processing technique, a speech recognition technique, an image recognition technique, a database technique, or the like, or any combination thereof. For example, a user may input a speech to the processing engine 112 and a speech search function (e.g., Google Voice™) based on a speech recognition technique built-in a user terminal may convert the speech to a text.

The text may include words, number, characters, or a combination thereof in any language, for example, Chinese, Japanese, English, or the like, or any combination thereof. In some embodiments, the text may be a combination of Chinese character(s) and letters, such as “Hai/Dian/Qu/Ai/Di/Sheng/Lu/3/Hao” (i.e., “No. 3 Edison Road, Haidian District”). “Hai” is a character, and “Hai/Dian” is a word. The text may have or have not word boundary tag, such as whitespace. For example, there is no boundary tag in Chinese text “Hai/Dian/Qu/Ai/Di/Sheng/Lu/3/Hao” of the words “Hai/Dian” and “Qu.” For another example, there is a whitespace in English text “No. 3 Edison Road Haidian District” of the words “Haidian” and “District.”

In some embodiments, the historical query may be a sound recording from a requester, and a speech recognition technique (e.g., a hidden Markov algorithm) may be used to convert the recording to a text.

In 730, the processing engine 112 (e.g., the segmentation module 420) may determine at least one subset of the text of the historical query. A plurality of techniques may be used in the text segmentation, for example, a model based technique, a word segmentation technique, a sentence segmentation technique, a natural language processing technique, a neural network technique (e.g., Error Back Propagation (BP) algorithm), a Lexical Cohesion technique, a Lexical Chains technique, a Lexical Cohesion Profile technique, a Latent Semantic Analysis, a Local Context Analysis, an Aspect Hidden Markov Model, a Probabilistic Latent Semantic Analysis, or the like, or any combination thereof.

In some embodiments, the text segmentation may be based on a CRF segmentation model. For example, 4-tag may be used in the CRF segmentation model. The 4-tag may be B (i.e., Begin), E (i.e., End), M (i.e., Middle), S (i.e., Single). The 4-tag may be used to mark the character of the text, for example,

| | |
|---|---|
| Hai | B |
| Dian | E |
| Qu | S |
| Ai | B |
| Di | M |
| Sheng | M |
| Lu | E |
| 3 | B |
| Hao | E |

According to the CRF segmentation model, four subsets of “Hai/Dian/,” “Qu/,” “Ai/Di/Sheng/Lu/,” and “3/Hao/” may be obtained for the text.

In 740, the processing engine 112 (e.g., the acquisition module 410) may obtain a POI associated with the historical query. The user may enter the query, which may be received by the processing engine 112 via the network 120. A search result including one or more POIs may be generated by the processing engine 112 and transmitted to the terminal device. The terminal device may display the search result to the user. The user may select a POI from the one or more POIs at the terminal device. The selected POI may be transmitted to the processing engine 112, which may further be associate the selected POI to the historical query. The processing engine 112 (e.g., the acquisition module 410) may obtain the POI associated with the historical query.

The POI may include address information, geographical location information, surrounding information, attribute information (e.g., spatial attribute information, entity attribute information), or the like, or any combination thereof. For example, a POI in Beijing may be a university, for example “Tsinghua University”. The POI “Tsinghua University” may include the full address of the university, a spatial attribute of the address, and an entity attribute of the address. For example, the address information of the POI “Tsinghua University” may be “Beijing City Haidian District Tsinghua University.” The spatial attribute of the address may include “Beijing City” and “Haidian District.” The entity attribute of the address may include “Tsinghua University.” The information of the POI may be stored in the storage 150 or retrieved from other storage (e.g., the terminal device 130), which may be accessed by the processing engine 112.

In some embodiments, a text of the POI may be segmented to as least one subset. For example, the POI may be “Beijing City Haidian District Tsinghua University” and the POI may be segmented into subset 1 “Beijing City,” subset 2 “Haidian District,” and subset 3 “Tsinghua University.” The segmentation technique may be same to the segmentation technique used in 730 described above.

In 750, the processing engine 112 (e.g., the labeling module 430) may determine an attribute for the at least one subset of the text of the historical query according to the POI associated with the historical query. The attribute may be a spatial attribute (e.g., labeled as “where”), an entity attribute (e.g., labeled as “what”), or the like, or any combination thereof. In some embodiments, the labeling module 430 may label the attribute for the at least one subset of the text using label the “where” for a spatial attribute and the label “what” for an entity attribute.

For example, a POI may be “Tsinghua University.” The address of the POI “Tsinghua University” may be “Bei/Jing/Shi/Hai/Dian/Qu/Qing/Hua/Da/Xue” (or “Beijing City Haidian District Tsinghua University” translated into English). A segmentation of the text of the POI may be “Bei/Jing/Shi//Hai/Dian/Qu//Qing/Hua/Da/Xue” with a word boundary tag of “IL” The spatial attribute of the detailed address may be “Beijing City” (i.e., Bei/Jing/Shi) and “Haidian District (i.e., Hai/Dian/Qu/).” The entity attribute of the address may be “Tsinghua University” (i.e., Qing/Hua/Da/Xue). In some embodiments, a user may input a query, a text of which may be “Haidian District Tsinghua University.” The user may select the POI “Tsinghua University” from a search result including one or more POIs.

The segmentation module 420 may segment the text “Haidian District Tsinghua University” into one or more subsets in 730. For example, in 730 the segmentation module 420 may segment the text “Beijing Haidian District Tsinghua University” into subset 1 “Beijing,” subset 2 “Haidian District,” and subset 3 “Tsinghua University.” In 740 the POI associated with the historical query (e.g., “Beijing City Haidian District Tsinghua University”) may be obtained as the spatial attribute is “Beijing City” and “Haidian District” and the entity attribute is “Tsinghua University.” The subset 1 “Haidian District” may be part of a spatial attribute of “Beijing City” and/or “Haidian District,” and the labeling module 430 may label the subset 1 “Haidian District” using the label “where.” The subset 2 “Tsinghua University” may be part of an entity attribute of “Tsinghua University,” and the labeling module 430 may label the subset 2 “Tsinghua University” using the label “what.” As another example, the segmentation module 420 may segment the text “Haidian District Tsinghua University” into subset 1 “Haidian” and subset 2 “District Tsinghua University.” The subset 1 “Haidian” may be within a spatial attribute of “Beijing City Haidian District Tsinghua University,” and the labeling module 430 may label the subset 1 “Haidian” using the label “where.” The subset 2 “District Tsinghua University” may not be part of the entity attribute of “Beijing City Haidian District Tsinghua University,” and the labeling module 430 may not label the subset 2. That is, the labeling module 430 may label “Haidian” using the label “where” and “Haidian” may be a labeled sample. The labeling module 430 may determine the attribute for the at least one subset of the text. Therefore, the labeling module 430 may automatically label the attribute for the at least one subset of the text using the label “where” and/or the label “what.”

As another example, a POI may be “Huilongguan Subway Station.” The full address of the POI “Huilongguan Subway Station” may be “Bei/Jing/Shi/Hai/Dian/Qu//Hui/Long/Guan/Di/Tie/Zhan” (or “Beijing City Haidian District Huilongguan Subway Station” translated into English). The spatial attribute of the address labeled with “where” may be “Beijing City,” “Haidian District” and “Huilongguan” obtained in 740. The entity attribute of the address labeled with “what” may be “Subway Station” obtained in 740. In some embodiments, a user may enter a query, a text of which may be “Huilongguan.” The user may select the POI “Huilongguan Subway Station” from a search result including one or more POIs. The segmentation module 420 may segment the text “Huilongguan” into only one subset “Huilongguan” in 730. The only one subset “Huilongguan” may be part of a spatial attribute of “Beijing City,” “Haidian District” and “Huilongguan” and the labeling module 430 may label the only one subset “Huilongguan” using the label “where.”

As another example, a full address of a POI “Huilongguan Mansion” may be “Beijing City Haidian District Huilongguan Mansion.” The spatial attribute labeled with “where” of “Beijing City Haidian District Huilongguan Mansion” may be “Beijing City,” and “Haidian District” obtained in 740. The entity attribute labeled with “what” of “Beijing City Haidian District Huilongguan Mansion” may be “Huilongguan Mansion” obtained in 740. In some embodiments, a user may enter a query, a text of which may also be “Huilongguan” in 710. The segmentation module 420 may segment the text of the query “Huilongguan” into only one subset “Huilongguan” in 730. The only one subset “Huilongguan” may be part of an entity attribute of “Beijing City Haidian District Huilongguan Mansion.” In this case, the labeling module 430 may label the only one subset “Huilongguan” using the label “what” but not the label “where” even if the same query, a text of which is “Huilongguan.” Therefore, for the same text of a query, different users may select different POIs, so that each of one or more subsets of the text may be labeled using different labels.

In 760, the processing engine 112 (e.g., the labeling module 430) may generate a historical training sample according to the determined attribute of the at least one subset of the text of the historical query. For example, the text of a historical query may be “Beijing City Haidian District Tsinghua University.”

The historical training sample may include a text extracted in 720, at least one subset of the text determined in 730, corresponding attribute (e.g., label “where” or label “what”) of each of the at least one subset of the text determined in 750, or the like, or any combination. Take “Beijing City Haidian District Tsinghua University” as an example, three subsets of the text of the historical query and corresponding attribute may be determined and shown in Table 1.

TABLE 1
an exemplary historical sample

| Subset of the text | Attribute of the subset | Label |
|---|---|---|
| Beijing City | Spatial attribute | Where |
| Haidian District | Spatial attribute | Where |
| Tsinghua University | Entity attribute | What |

The historical training sample may be stored in the storage 150 or other storage (e.g., the passenger terminal(s) 130 or the driver terminal(s) 140) in the on-demand service system 100. The training module 440 may train the preliminary CRF model based on the historical training sample as described in FIG. 6.

It should be noted that the processing engine 112 described above is provided for the purposes of illustration, and not intended to limit the scope of the present disclosure. Apparently, for persons having ordinary skills in the art, numerous variations and modifications may be conducted under the teaching of the present disclosure. However, those variations and modifications do not depart the protection scope of the present disclosure. In some embodiments, some steps may be reduced or added. For example, 720 may be omitted. A query may be in the form of a text and the text may be obtained without text extracting. As another example, 730 may be omitted. In some embodiments, a text may not need to be segmented (e.g., “China”). In some other embodiments, a text may be obtained with a form of has been segmented. Similar modifications should fall within the scope of the present disclosure.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one computer-readable storage medium including a set of instructions for managing supply of services; and
at least one processor in communication with the at least one storage medium, wherein when executing the set of instructions, the at least one processor is directed to:
receive, via a network, a query from a terminal device;
operate logical circuits in the at least one processor to extract a text from the query;
operate the logical circuits in the at least one processor to determine one or more subsets of the text;
operate the logical circuits in the at least one processor to obtain a trained conditional random field (CRF) model; and
operate the logical circuits in the at least one processor to determine an attribute for each of the one or more subsets of the text based on the CRF model and the each of the one or more subsets of the text.

2. The system of claim 1, wherein the attribute for each of the one or more subsets of the text includes at least one of a spatial attribute or an entity attribute.

3. The system of claim 2, wherein the attributes for the one or more subsets of the text include at least a spatial attribute having a first label.

4. The system of claim 3, wherein the attributes for the one or more subsets of the text further include at least an entity attribute having a second label.

5. The system of claim 1, wherein the at least one processor is further configured to determine a probability for the determined attribute for the each of the one or more subsets of the text.

6. The system of claim 1, wherein the trained CRF model is generated according to a process for generating a CRF model, the process comprising:
obtaining a preliminary CRF model;
obtaining a plurality of training samples;
determining a feature template;
determining one or more feature functions based on the plurality of training samples and the feature template; and
training the preliminary CRF model based on the one or more feature functions to generate the trained CRF model.

7. The system of claim 6, wherein the plurality of training samples include a historical sample, the historical sample being generated according to a process for generating the historical sample, the process comprising:
obtaining a historical query;
extracting a text from the historical query;
determining at least one subset of the text of the historical query;
obtaining a POI associated with the historical query;
determining an attribute for the at least one subset of the text of the historical query according to the POI associated with the historical query; and
generating the historical sample according to the determined attribute and the at least one subset of the text of the historical query.

8. The system of claim 6, wherein the feature template comprises at least one of a fine feature, a generalized feature, or an individualized feature.

9. The system of claim 8, wherein the fine feature comprises at least one of a feature of a current word, a feature of a preceding word of the current word, a feature of a following word of the current word, a relationship of the current word and the preceding word of the current word, a relationship of the current word and the following word of the current word, a relationship of the preceding word of the current word and the following word of the current word, a relationship of the feature of the current word and the feature of the preceding word of the current word, a relationship of the feature of the current word and the feature of the following word of the current word, or a relationship of the feature of the preceding word of the current word and the feature of the following word of the current word.

10. The system of claim 8, wherein the generalized feature comprises at least one of a number, a letter, a character size, a prefix, or a suffix.

11. The system of claim 8, wherein the individualized feature comprises at least one of identity number information related to a user associated with the terminal device, a query time, or location information of the terminal device.

12. A method implemented on at least one device each of which has at least one processor, a storage, and a communication platform to connect to a network, the method comprising:
receiving, via the network, a query from a terminal device;
extracting a text from the query;
determining one or more subsets of the text;
obtaining a trained conditional random field (CRF) model; and
determining an attribute for each of the one or more subsets of the text based on the CRF model and the each of the one or more subsets of the text.

13. The method of claim 12, wherein the attribute for each of the one or more subsets of the text includes at least one of a spatial attribute or an entity attribute.

14. The method of claim 13, wherein the attributes for the one or more subsets of the text include at least a spatial attribute having a first label.

15. The method of claim 13, wherein the attributes for the one or more subsets of the text include at least an entity attribute having a second label.

16. The method of claim 12, further comprising determining a probability for the determined attribute for the each of the one or more subsets of the text.

17. The method of claim 12, wherein the trained CRF model is generated according to a process for generating a CRF model, the process comprising:
obtaining a preliminary CRF model;
obtaining a plurality of training samples;
determining a feature template;
determining one or more feature functions based on the plurality of training samples and the feature template; and
training the preliminary CRF model based on the one or more feature functions to generate the trained CRF model.

18. The method of claim 17, wherein the plurality of training samples include a historical sample, the historical sample being generated according to a process for generating the historical sample, the process comprising:
obtaining a historical query;
extracting a text from the historical query;
determining at least one subset of the text of the historical query;
obtaining a POI associated with the historical query;
determining an attribute for the at least one subset of the text of the historical query according to the POI associated with the historical query; and
generating the historical sample according to the determined attribute and the at least one subset of the text of the historical query.

19. The method of claim 17, wherein the feature template comprises at least one of a fine feature, a generalized feature, or an individualized feature.

20-22. (canceled)

23. A non-transitory computer readable medium, comprising at least one set of instructions for providing an on-demand service, wherein when executed by a processor, the at least one set of instructions directs the processor to perform acts of:
receiving, via a network, a query from a terminal device;
extracting a text from the query;
determining one or more subsets of the text;
obtaining a trained conditional random field (CRF) model; and
determining an attribute for each of the one or more subsets of the text based on the CRF model and the each of the one or more subsets of the text.
